(19) United States
(12) Patent Application Publication
(10) Pub. No.: US 2003/0141360 A1
(43) Pub. Date: Jul. 31, 2003

(54) System and method for providing information and services to and from an automated teller machine

(76) Inventors: Stephen L. De Leo, New York, NY (US); Hope L. Kirschner, Framingham, MA (US); Robert W. Vesterman, Mine Hill, NJ (US)

Correspondence Address: David G. Wille, Esq., Baker & Botts, L.L.P., Suite 600, 2001 Ross Avenue, Dallas, TX, 75201-2980, US

(21) Appl. No.: 10/259,235

(22) Filed: Sep. 26, 2002

Related U.S. Application Data
(63) Continuation-in-part of application No. 10/095,924, filed on Mar. 11, 2002, now Pat. No. 6,567,842.
Application No. 10/095,924 is a continuation of application No. 09/296,353, filed on Apr. 22, 1999, now Pat. No. 6,381,626.

(51) Int. Cl. G06F 17/60

(52) U.S. Cl. 235/379

(57) ABSTRACT

An automated teller machine (ATM) system includes a central office, an ATM coupled to the central office, and a remote data provider coupled to the central office. The ATM performs bank transactions in response to user interaction. The remote data provider is operable to provide enhanced non-bank transaction content to the ATM through the central office.

### RELATED APPLICATIONS

This application is a continuation-in-part application of U.S. application Ser. No. 10/095,924 which is a continuation application of U.S. application Ser. No. 09/296,353 now U.S. Pat. No. 6,381,626 B1.

### TECHNICAL FIELD OF THE INVENTION

The present invention relates in general to automated teller machines and more particularly to specifically to system and method for providing information and services to and from an automated teller machine.

### BACKGROUND OF THE INVENTION

Automated teller machines (“ATM”) are deployed in great numbers throughout the United States. The typical ATM is an intelligent computer-based machine that is attached to a controlled electronic messaging network. In a typical implementation, the ATM machine is attached by a leased line to a central office where the functions of the ATM can be monitored. ATMs typically have only been used for various banking purposes. These uses include withdrawing cash from checking or savings accounts, accepting deposits, transferring funds between accounts, and checking account balances of various accounts accessible through the ATM.

In today's changing marketplace disparate, networks are being joined or converged together to increase the reach of each network and provide better services to users. An example of a converged network is WEBTV. WEBTV combines the reach and content of television with the interactivity of the Internet. Another important concept is that of tracking user preferences in order to make them available to appropriate vendors willing to pay for access to user behavior. One drawback of current marketing strategies is that they are not tailored to individual users or lack the structure to tailor to individual users. Also, users may be reluctant to utilize new technologies and are slow to embrace new infomediaries and networks due to lack of trust and inherent cost involved in acquiring new technology to take advantage of these advances.

Additionally, in today's structure, the reach of traditional advertising programs is based on demographics and not on actual user reaction. For example, broadcast advertising is done as either a general advertisement to all users or advertisements are run based on the demographics of the viewer or reader. What is needed is a way to converge interactive networks with a trusted establishment network like the automated teller machine network.

### SUMMARY OF THE INVENTION

From the foregoing, it may be appreciated by those skilled in the art that a need has arisen to enhance services available at an automated teller machine. In accordance with the teachings of the present invention, a system and method for providing information and services to and from an automated teller machine are provided that substantially eliminate or greatly reduce disadvantages and problems associated with conventional automated teller machine implementations.

According to an embodiment of the present invention, there is provided a system for providing information and services to and from an automated teller machine that includes a central office, an Automated Teller Machine (ATM) coupled to the central office and a remote data provider coupled to the central office. The ATM performs bank transactions in response to user interaction. The remote data provider is operable to provide non-bank transaction content to the ATM through the central office. In another embodiment of the present invention, there is provided a method for providing information and services to and from an ATM that includes requesting enhanced content from a central office based on a user selection. The enhanced content is retrieved from a remote data provider. The enhanced content is then provided to the ATM for display to a user.

The present invention provides various technical advantages over conventional ATM implementations. For example, one technical advantage is that various information services from third party data providers can be integrated and displayed on an ATM. Another technical advantage is that information gathered from the ATM can be readily accessed by a provider of ATM services. Other technical advantageous may be readily ascertainable by those skilled in the art from the following figures, description, and claims.

### BRIEF DESCRIPTION OF THE DRAWINGS

For a more complete understanding of the present invention, and for further features and advantages, reference is now made to the following written description taken in conjunction with the accompanying drawings, in which:

FIG. 1 illustrates a block diagram of a transaction system;

FIG. 2 illustrates a block diagram of an exemplary host computer system of the transaction system;

FIG. 3 illustrates a block diagram of an exemplary transaction terminal of the transaction system;

FIG. 4 illustrates a time chart indicating a sequence of operation of the transaction terminal, the host computer system, and a terminal screen load sequence for an exemplary transaction;

FIG. 5 illustrates a system providing data to an automated teller machine;

FIG. 6 illustrates a typical automated teller machine;

FIG. 7 is a flowchart illustrating an example process implemented in providing data to the automated teller machine;

FIG. 8 illustrates a multi-channel interactive distribution system for the interconnection of automated teller machines and the Internet;

FIG. 9 is a flowchart illustrating one operational embodiment of the multi-channel interactive distribution system;

FIG. 10 is a flowchart illustrating a user's use of the multi-channel interactive distribution system;

FIG. 11 is a flowchart illustrating the use of the multi-channel interactive distribution system;

FIG. 12 is a flowchart illustrating and tracking of users in the multi-channel interactive distribution system;

FIG. 13 illustrates a generic structure of the multi-channel distribution system.

### DETAILED DESCRIPTION OF THE INVENTION

A preferred embodiment of a system for practicing the present invention is shown with respect to an application of the invention to an automatic banking transaction system having at least one host computer and a plurality of transaction terminals, such as automated teller machines (ATMs) for use by authorized users. Such systems are well known and widely used by banks to enable their customers to obtain cash, make deposits, transfer funds, make payments, perform balance inquires, etc. without waiting in line for a teller and during extended hours when banks are closed.

While the system is described with respect to banking terminals, such as ATMs, those familiar with the art will recognize that the present invention can be applied to a broad range of transaction terminals that use a video monitor for communicating with a terminal user, including, for example and not by way of limitation, terminals for vending airline or rail tickets, theater tickets, prepaid telephone cards, gasoline, etc.

In particular, terminals are arranged to have a data storage facility, such as a disk drive or CD ROM, which stores audio, video or graphic messages to be displayed to a terminal user during a transaction.

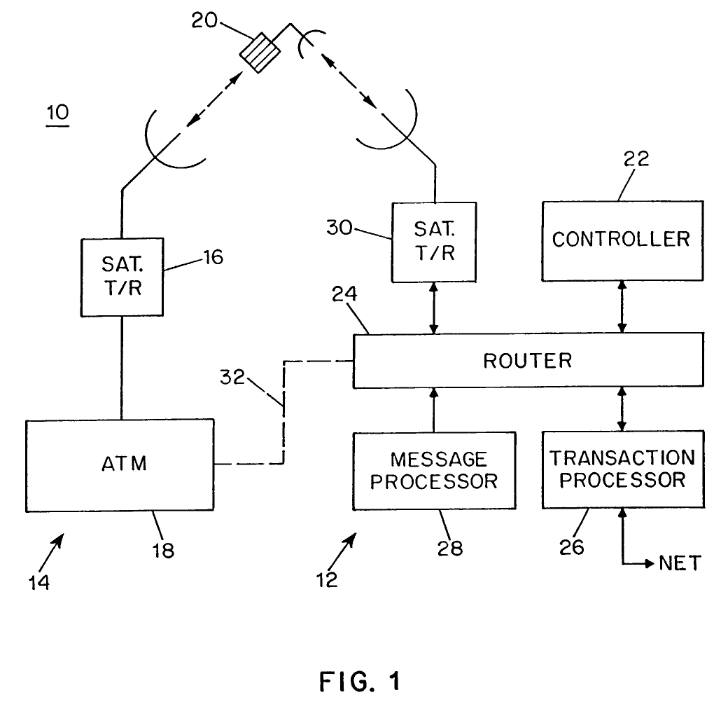

Referring to FIG. 1, there is shown a system 10 according to a preferred arrangement, which includes a host 12 and a transaction station 14. Transaction station 14 includes an ATM 18, and preferably a communications station 16 for receiving and optionally transmitting data to host 12. Preferably, communication station 16 takes the form of a satellite communication link, but other high bandwidth communications systems can be implemented in the alternative.

In the example shown in FIG. 1, host 12 includes a controller 22, which performs host control functions and oversees host communications. Router 24 manages communications between transaction processor 26, message processor 28 and transaction station 14 associated with the host 12. Such communications include routine transaction messages, for purposes of handling banking transactions, that are processed by transaction processor 26. In addition, message processor 28 communicates messages, such as video segments and message delivery instructions, called configuration files, to terminals 18, for providing non-transaction messages to a user of a terminal, as will be described. Preferably, the video segments are stored and transmitted in a standard compressed video format, such as MPEG (Motion Picture Expert Group).

System 10, includes three distinct communications message content types, which will be defined for further understanding.

Message files, as used herein, refer to data files representing video, graphic, and/or audio information, which may be in a format, such as MPEG, which enables substantially real time read-out of message file data from a data storage device, and video, graphic, and/or audio reproduction of the message to a user at a terminal.

Configuration files are data files used to control the selection and presentation of message files at a terminal. Typically configuration files designate the message files to be presented to a terminal user during designated periods of time, preferably by hour and day. Configuration files may also be arranged to select particular messages upon command by either the terminal processor or the host 12, wherein messages are selected according to transaction data or other criteria, as will be discussed.

Transaction data, as used herein, refers to digital data relating to the primary transaction requested by the user. Typical transaction data would include data read from the banking card, debit card or credit card of a terminal user; data entered by a user, such as the PIN number, transaction type, transaction amount, etc. and data sent by the host 12 relating to the transaction, such as requests for further information regarding selection of an account, regarding a usage fee, transaction approvals or transaction denial messages and responses to such requests.

Typically, systems that include a host 12 and a plurality of transaction stations 14 provide data communications between the host 12 and the terminals 14 utilizing land lines, such as dedicated or dial-up telephone lines. Because of bandwidth limitations, conventional telephone lines are not well suited for sending large message files from the message processor 28 of host 12 to transaction stations 14. Transmission bandwidth on telephone links is so limited that sending a message file corresponding to a short, e.g. 15 second, video segment, even in compressed MPEG format, would require lengthy or excessive transmission time, which would impair the communications required to process transactions, the primary function of system 10. Accordingly, it is preferred to provide other means for providing message files to transaction stations 14. One such technique is physically transporting a storage device such as tapes, discs or CD ROM devices, having the required messages to transaction stations 14 and having the storage devices installed by those normally servicing the terminal, when they go to the transaction station 14 to load cash dispensers, to load receipt printer tape, or perform other servicing functions. It is preferable, however, to provide an electronic data delivery technique, whereby message files and configuration files can be frequently updated and changed.

The system 10 of FIG. 1 utilizes a satellite communications network having terminal satellite station 16, host satellite station 30 and satellite 20 to deliver message files, and also configuration files to terminals 18 of transaction stations 14. In particular a broadcast or multicast technique is used to simultaneously send message files and configuration files to multiple transaction stations 14. Alternately message files can be broadcast over the satellite network while configuration files are sent by land lines. Transaction messages can be sent and received by Host 12 using either the satellite communications network or conventional land lines 32.

It should be understood that the system is not confined to physical delivery or satellite broadcast of message files. Other data delivery techniques having sufficient bandwidth for this task include, for example, ISDN high bandwidth telephone link, fiber optic link, coaxial cable, broadband microwave links and the like.

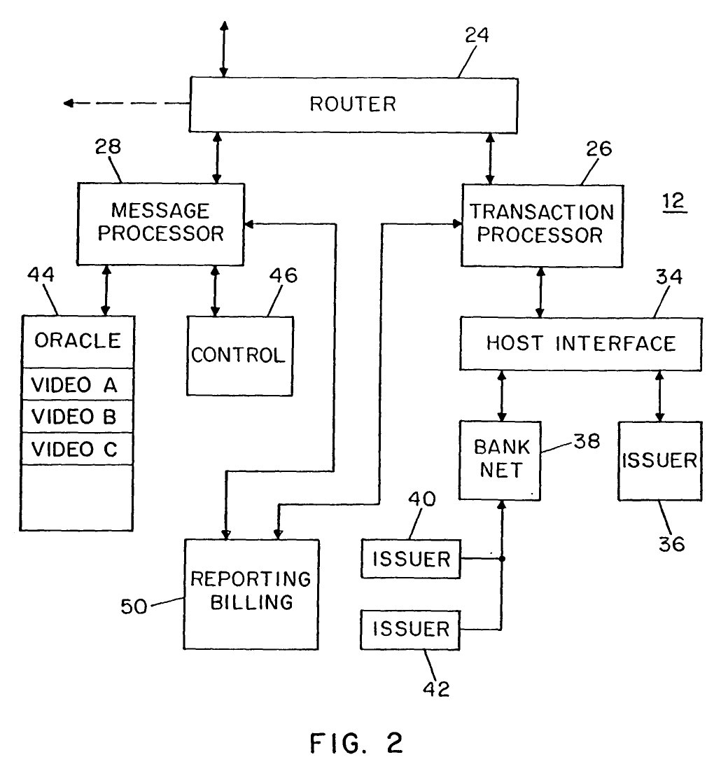

Host 12 is shown in greater detail in FIG. 2. In one embodiment, the message processor 28 is a Unix-based system which stores video message files in an Oracle based database 44, however, the practice of the invention is not limited to this exemplary operating system and database software. The system is operated using a control computer 46, which operates message processor 28 to generate broadcast messages by which message files are sent to terminals 18 at transaction station 14. It should be understood that different message files can be distributed to various terminals 18 in system 10, so that the terminals 18 can display non-transaction messages that can be coordinated to various campaigns. Accordingly, for each broadcast of a message file, message processor 28 is controlled by control computer 46 to prepare a broadcast header which specifies the terminal or terminals which are to receive and store the message file. Accordingly, based upon the message header, a message file may be sent to one terminal, to a number of designated terminals, to all terminals or to all terminals in a class, e.g. terminals of a particular type, those with a particular network affiliation, those associated with a particular bank or a particular retail chain or to terminals in a particular geographic area.

Once message processor 28 formulates the message file with its associated message header, it is passed onto the router 24 for possible assembly with other message files and thereafter transferred to the satellite transmission station 30 for broadcast. Alternately, the message file may be recorded on a storage media, such as a disc memory or CD ROM and transported to terminals 18 by service personnel. Alternately, router 24 may send the message file to terminal 18 over a suitable communication backbone such as an ISDN, fiber optical transmission line, cable network, broadband microwave link or other suitable communication path.

In addition to message files, message processor 28, in connection with control computer 46, is used for the formulation of configuration files. Configuration files are data files used by terminals 18 to control which message file, previously sent to terminal 18, is to be displayed to a terminal user. Configuration files, for example, may cause message files to be selected and displayed at different times of the day. For example, a message file promoting a fast-food restaurant may be displayed during the period 11AM to 2PM to promote lunch trade, while a message file promoting a motion picture may be selected in the period 4PM to 8PM. Other messages, for example, promoting an automobile might be available for selection in rotation at any time of day or as “default” selection, during times when other messages have not been designated for display. The configuration file can also include data relating to printed promotional materials, such as coupons, associated with selected message files.

The configuration file may also control the rotation of message file selection, at the terminal. For example, a configuration file may cause a terminal to select in rotation among a plurality of message files. The configuration may cause some message files to be selected more frequently than others.

The configuration file may also be arranged to cause the terminal 18 to select message files according to transaction data. For example, a message may offer a user having an account at another bank an incentive to transfer his account to the bank controlling a particular terminal, such as free checking for one year. This message would not be selected for presentation to the bank's own customers who are charged for checking. This selection may be made using data read from the banking card presented at the terminal. Further, users who present a card issued in another country might cause selection of a message promoting tourist services. Further, users who request a transaction in an alternate language might cause selection of a message file having a corresponding language text or audio. Further, different message files might be selected according to the transaction amount. These features may be implemented by the host 12 on terminal 18.

The configuration file can also respond to message file selection signals originated by host 12 or the issuer, wherein selection can be made on the basis of data known to the host or issuer such as account balance. Accordingly, the host or issuer can identify the terminal user as high net worth individual and provide a demographically targeted non-transaction message promoting luxury automobiles or investment services. Alternately, a customer who has recently paid off a car loan may be targeted with messages promoting new cars, auto loans or auto-leasing. A user whose transaction has been denied by the issuer may receive a message designated by the host promoting its services for banking or credit.

In one arrangement, configuration files are formulated and sent to transaction terminals 18 on a periodic basis, according to the requirements of the message sponsors. Each configuration file may provide operating instructions to be used for a 12-or-24 hour period or until replaced by a succeeding configuration file. Typically, a first configuration file may be effective for a period starting at midnight. While the first configuration file is being used, a second subsequent configuration file effective starting at noon is sent to the terminal 18. Preferably, the host 12 sends the second configuration file at a time sufficiently in advance of the noon effective time so that its receipt by terminal 18 can be confirmed. In the absence of confirmation, the configuration file can be resent by host 12. In the event a terminal 18 fails to receive a new configuration file by the noon expiration of the first configuration file, a default procedure can be implemented for continued use of the first configuration file.

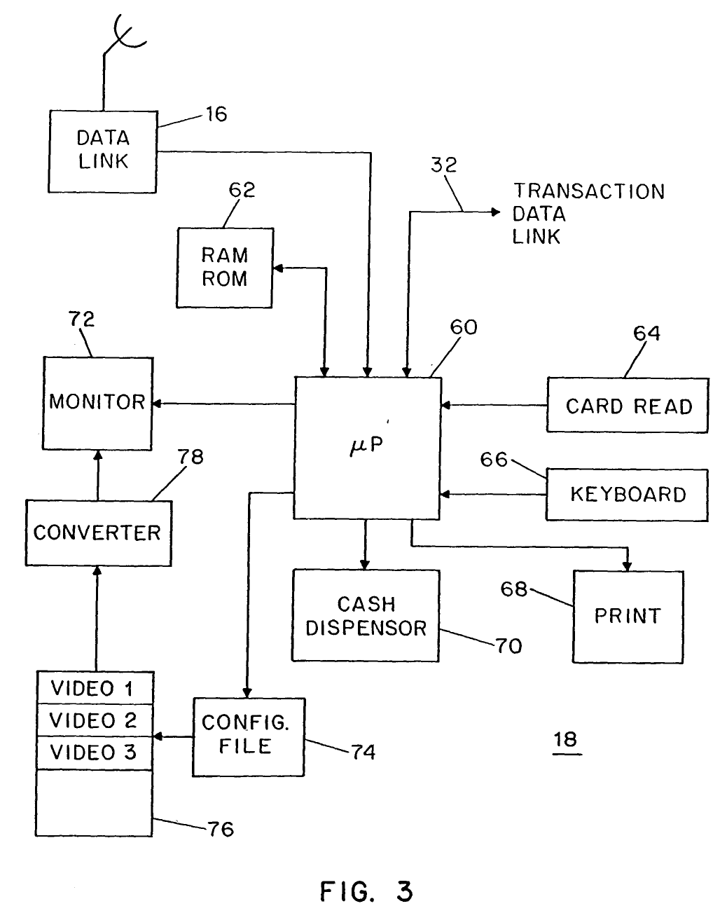

Referring to FIG. 3, there is shown a terminal ATM 18 for displaying non-transaction messages. Terminal 18 includes a processor 60, memory 62, cardreader 64, keyboard 66, printer 68, dispenser 70 and monitor 72 similar to corresponding elements included in a conventional ATM. The actual hardware included in a terminal will depend on the functions required. For example, a ticket vending terminal may have a ticket printer or a ticket dispenser instead of a cash dispenser. The processor 60 is preferably a high speed processor, such as a 166 MHZ or faster Pentium processor. Memory 62 preferably includes at least 16 MB or more of RAM. There is additionally provided a data storage device 76 for storing message files. The data storage device 76 is preferably a 2 GB or larger hard disk drive, optical CDROM drive, tape drive and the like. Where message files are hand carried to the terminal, a CDROM drive may be used. A data-to-video converter 78, which may be an MPEG-1 video card with audio is provided.

The configuration file 74 which is downloaded from the message processor 28 is used to control the selection of message files from storage device 76. The processor 60 interfaces with data communications equipment, which may include satellite station 16 or a cable connection and conventional telephone line 32. It should be noted that in some locations, such as a bank office, where multiple terminals 18 are co-located, such terminals may share access to satellite station 16 or cable connection and/or to telephone line 32. In some cases, a directed advertising campaign may include printed promotional materials, such as coupons, which are associated with a non-transaction message. For example, an advertisement for a local fast food establishment can have an associated coupon for a daily meal discount. Such promotional materials can be fixed incentives or customized based on the demographics of the user. In either case, the printer 68 is preferably used to generate and dispense such material. Alternatively, preprinted promotional materials related to selected non-transaction messages or transaction data can be loaded into the dispenser 70 for distribution of such materials. While only a selected number of such materials can be loaded in the dispenser 70, those materials can offer higher quality typesetting and the like than can normally be achieved by the printer 68.

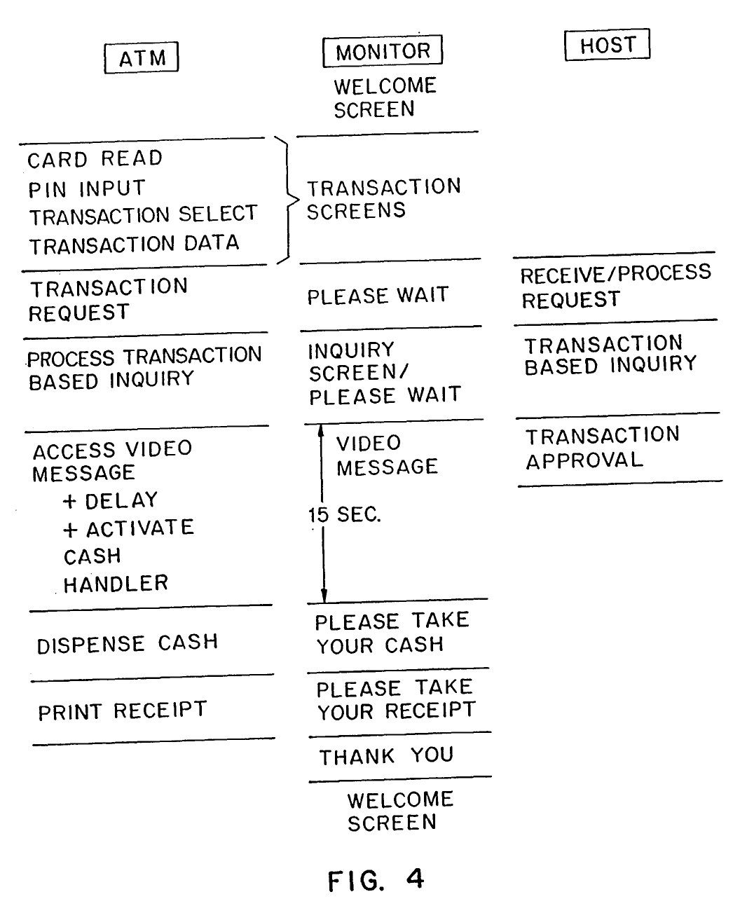

FIG. 4 is a diagram illustrating an exemplary sequence of events in connection with a transaction and display of a non-transaction message. The diagram includes events at the ATM processor, the ATM monitor and the host system. The display activity is generally referred to as the “screen load”.

Initially the ATM is in a standby condition and displays a “welcome screen” that greets a user and indicates how to initiate a transaction, such as by inserting a bank card in the card reader. When a user inserts a bank card, the ATM reads the card information and places the data in a buffer memory. The ATM then displays a series of screens requesting, for example, entry of the user's PIN, selection of a transaction type, and, if appropriate, entry of a transaction amount. Responsive data is also placed in a buffer memory. This series of screens has a time duration which depends on the user's response. Excess delay, such as more than one or one and a half minutes, results in a “time out” condition and may terminate the transaction process. In the event of termination of the transaction process, the terminal returns to the welcome screen and standby condition. When all the transaction data has been entered, the ATM assembles a transaction request containing the entered transaction data and sends the request to the host 12 for processing. A “please wait” message is displayed.

At host 12, the transaction request is routed to transaction processor 26, which can perform preliminary examination of the request to determine whether the originating terminal can perform the requested transaction. For example, the transaction processor 26 can determine whether the terminal has sufficient cash or the proper denomination of bills to satisfy the requested transaction (i.e., the terminal might only be loaded with $20 bills and be unable to satisfy a requested amount such as $25). The transaction processor 26 also determines the institution that has responsibility for the user's account, called the issuer, and routes the transaction request data to the issuer through the host interface 34, either directly to an issuer 36, or through bank network 38 to issuers 40 or 42. It is understood that the customer's account may be administered for authorization purposes by another institution which performs the issuer function. In many instances the host or the issuer returns further inquires concerning the transaction, such as a request for concurrence to a transaction fee, or a request to designate an account from which cash is to be withdrawn or accounts between which transfers are to be made. These data inquires are sent to the ATM and prompt further screen requests for input of transaction data by the user. After the user responds to the inquires the screen again displays a “please wait” message.

When the transaction is approved, a signal is sent from the host 12 to the ATM 18 which causes the ATM 18 to access the configuration file 74, select a message file and display a non-transaction message. Preferably all messages have a fixed time duration, such as 15 seconds, so that the video display interval in the screen load is the same, independent of which message file is selected. In order to coordinate the ATM operation with the video presentation, operation of the ATM may be delayed. For example, in one arrangement the signal from the host to the ATM which occurs upon transaction approval does not activate the ATM to dispense cash or print a transaction record, but merely starts the video display. Approximately seven seconds or an appropriate time later, a further message from the host activates the ATM 18, to dispense cash or to print a record while the video message is being displayed. This delay allows adequate time for completion of the 15 second video before the cash or printed record is presented and the screen displays the next transaction message.

Alternatively, the seven second delay might be arranged in the ATM 18, wherein the signal from the host provides transaction approval, but the ATM 18 delays the cash dispensing or record printing during a first portion of the video display, such as seven seconds, before activating the cash dispenser or printer.

Accordingly, the user is given the impression that the ATM is continuing to work without delay for the video, because he or she hears the dispenser or printer operating during the video message. Further, when the user hears the cash dispenser operating he or she has a positive disposition toward the message being displayed.

After the video message presentation, the ATM proceeds through the usual steps to complete the transaction as shown in FIG. 4.

While it is possible to start the video display prior to transaction approval, such as after the transaction-based inquiries are completed, the possibility of displaying a message and then having a transaction denied can leave a negative impression with the user. Accordingly, it is considered to be preferable that the message be displayed only in connection with approved transactions. In some instances, a message may be selected to be displayed upon receipt of a denial message, such as a message suggesting the services of another financial institution.

It is also possible for non-transaction messages to be displayed intermittently during the welcome screen, particularly where the terminal is in a public location, such as a ticket vendor at a train station or airport.

An important feature is the ability to use the configuration file to specifically tailor presentation of messages by time, and in some cases by user characteristics. Accordingly commercial message delivery can be specific and delivered to a user who is paying attention to the monitor. The display of messages to the user is recorded by the ATM 18 in the form of a detailed “play log”. The play log can include detailed reporting regarding each non-transaction message including the time, location, customer demographics, and other such information related to the display of the message. The play log data can be provided to the message processor 28 for purposes of reporting and billing to a sponsor of the message. Such a detailed reporting log is useful to the sponsor in judging the performance of the non-transaction messages.

It should be noted that when message files, configuration files and transaction data are transmitted by satellite link as shown in FIG. 1, the communications from terminals 18 to host 12 do not require the same bandwidth as the communications in the other direction which carry the message files. Accordingly, a high bandwidth transmission rate and protocol, such as 512 Kbps is appropriate for the message files, and a lower bandwidth (and data rate) protocol such as 128 Kbps (or other reasonably lower data rate) can be used for transferring configuration files, transaction data and acknowledgment messages. The use of lower bandwidth communication channels, where possible, reduces the processing and transmitter power requirements for the communications station 16 associated with transaction stations 14.

While the exemplary transaction described relates to a banking transaction, such as a cash withdrawal a similar, process can be used with respect to other terminal-based transactions, such as purchase of an airline, railroad or theater ticket.

As shown in FIG. 2, the transaction data messages from transaction processor 26 and the message files and configuration files from message processor 28 are both organized in router 24 and sent to terminals 18 preferably by satellite transmitter/receiver 30. Transaction data messages and acknowledgment of message file transmissions and configuration file transmissions are also preferably received through satellite transmitter/receiver 30.

An alternate is to provide entirely separate communications between transaction processor 26 and terminals 18 for transaction data, as now provided using telephone line 32, and broadcast of message files using satellite terminal 30. Configuration files, which are not as large as message files can either be sent via satellite broadcast or using telephone lines, either by the same router 24 or a completely separate router.

It should be noted that the message processor 28 and associated communications may be an entirely separate system from the transaction processor 26, such that a message processor can communicate with terminals associated with different transaction processors 26 at different host sites.

FIGS. 1-4 provide a specific implementation where stored non-transaction messages may be provided to a user of an ATM during a banking transaction. The concept discussed above may be expanded and enhanced to provide additional services to an ATM user whether or not a banking transaction is taking place. FIGS. 5-7 discuss a system for the delivery of enhanced content to an ATM.

FIG. 5 illustrates a system 100 for providing information to an automated teller machine (ATM). System 100 includes an ATM 102 connected by a data link 104 to a central office 106. Central office 106 includes a data source system 108 connected to an internal operation terminal 110 and an internal database 112. Central office 106 connects to a remote data provider 114, a remote client database 116, and an external client terminal 118. Remote data provider 114, remote client database 116, and external client terminal 118 are in communication with data source system 108 of central office 106.

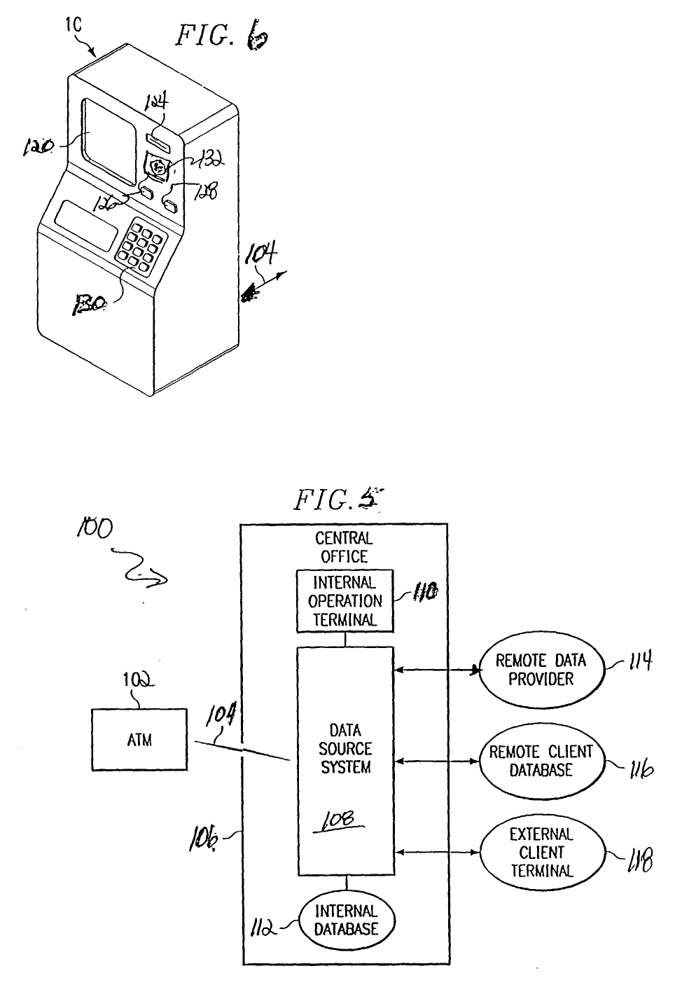

FIG. 6 illustrates an embodiment of ATM 102. ATM 102 is a conventional automated teller machine. ATM 102 includes a screen 120, a card reader 124, a printer dispenser 126, a money dispenser 128, a keypad 130, an audio unit 132. In operation, the user approaches ATM 102 and inserts an identification card into card reader 124. Card reader 124 is operable to interpret and read the magnetic strip on a back of the user's card. In another embodiment, card reader 124 might be operable to read a smart chip placed in a card or waved in front of card reader 124 by the user. Once the card is read, ATM 102 will respond visually on screen 120 with an indication that the card has been inserted and for the user to type a password or personal identification number (PIN) on keypad 130. The user then enters the PIN via keyboard 130. A menu of choices will be displayed to the user on screen 120 upon validation of the PIN. In a typical financial application setting, the menu choices might include an ability to withdraw cash, deposit a check, transfer funds to an account, and provide account balances. To use ATM 102 to withdraw a certain amount of money would require the user to select the withdraw money choice and enter the amount of money to be withdrawn on keypad 130. The money is dispensed by money dispenser 128 and a receipt printed and dispensed by receipt printer 126.

Information regarding transactions performed by the user is sent by data link 104 that provides an interface between ATM 102 and data source system 108. Data link 104 may be a leased line, a dedicated connection, a dialup connection, a fiber optic link, or any other wire or wireless connection. Information can be stored locally at ATM 102, at central office 106, or retrieved externally therefrom. An example of information stored and retrieved includes the non-transaction messages and video advertisements discussed above in FIGS. 1-4.

Central office 106 is where the ATM operator is located. An ATM operator is considered a full service center, owner, operator, driver, and program manager of the system and functionalities for ATM 102. These operators offer, create, and control the functionality of ATM 102 on behalf of its owners.

At ATM 102, certain events might occur that trigger operation of other parts of data source system 108. Triggering events may include any user transaction including the use of an ATM card, the entry of a PIN number, or a request for a transaction. Other triggering events may include an ATM configuration change, including hardware or software changes, that may occur throughout the course of the day or over a period of time. Other triggering events include data requests, delivery, and receipt as well as any other operation associated with the ATM transaction experience. These events are monitored by central office 106. Triggering events can cause information to move between ATM 102 and data source system 108 in order to create a data and informational channel to and from ATM 102.

Data source system 108 contains applications and servers that manage data storage, access, movement, and usage among the various inputs and outputs of data source system 108. These applications may support internal operator terminal 110, data storage in internal database 112 for programs occurring at ATM 102, links to remote client databases 116, caching of data from remote data provider 114 to be sent to ATM 102, and an access point for clients to input their own data and perform their own monitoring through external client terminal 118.

Internal operator terminal 110 is used by central office employees to monitor the flow of the content and data to and from external client terminal 118, remote data provider 114, ATM operators at central office 106, and ATM 102. Internal operator terminal 110 also ensures that ATM 102 is active, responsive, and handling data correctly. Internal operator terminal 110 is also operable to be used to enter configuration changes to ATM 102, including limiting the availability of certain transactions to specific times of day. Additionally, internal operator terminal 110 could be used to trace ATM 102 and system faults that occur at data source system 108.

Internal databases 112 include data storage facilities to support data source system 108 as well as providing data storage for information to and from remote data provider 114.

Remote data provider 114 supplies data and content for use at ATM 102 in a real time or stored environment. An example of content and data that may be supplied include a news provider for providing news, weather, sports, or other information that could be sold to, subscribed to, or viewed by the user of ATM 102. Another content example may be an airline or number of airlines which allow its reservations systems to be used in order for the user of ATM 102 to purchase a ticket or boarding pass. Additionally, remote data provider 114 could provide services for allowing the purchase of movie tickets, theater tickets, or tickets to sporting events. Remote data provider 114 could also provide a gateway to financial services provided by electronic traders or other broker houses. Remote data provider 114 is, therefore, an entity outside the ATM system that can provide a variety of information and/or services to ATM 102. The user may make purchases at ATM 102 with certain purchases being dispensed through printer dispenser 126.

Remote client databases 116 store information for retrieval by various ATM owners and card owners about their ATMs and accounts. This information can be used during or before an ATM transaction to modify the ATM transaction. For example, information regarding the user stored at remote client database 116 may indicate that the user may have a home mortgage at that bank. When the user is using ATM 102, information in remote client database 116 can provide information regarding the refinancing of a home mortgage from the ATM owner or card owner to the user at ATM 102. Additional information could be used to further redefine and tailor the ATM use experience for different users depending upon their needs. Therefore, instead of a static ATM 102 where every screen is the same for every person that uses ATM 102, screen images can be tailored to the preferences of individual users.

External client terminal 118 is an external terminal that allows an ATM owner or card owner to access, monitor, modify, or update information and applications associated with ATMs owned by them or used by their card holders. Though one ATM 102 is shown attached to central office 106, multitudes of ATMs 102 could be attached to one central office 106.

Data source system 108 creates an informational delivery channel for providing information to ATM 102 as well as retrieving data from ATM 102. In operation, the user visits ATM 102 and logs on to ATM 102 via the use of an identification card and password or some other way of identifying and verifying the user. The identification card and password may be the same as or different from those used in performing banking transactions at ATM 102. In one embodiment, the user may be given the option to access information such as news headlines, sports scores, and stock quotes. This information may be provided by remote data provider 114 to ATM 102 via data source system 108. The user may also be given the opportunity to access e-mail, Internet services, or home banking from ATM 102.

In another embodiment, information from remote data provider 114 may include advertising, marketing information, and promotional campaigns delivered to ATM 102 via data source system 108. As discussed above, FIGS. 1-4 show one example of providing advertising non-transaction messages to the user at ATM 102. ATM 102 may recognize identity information concerning the user. Based on this information, specific information tailored to the user can be delivered to ATM 102 via data source system 108 from remote client database 116 or remote data provider 114. This could include information the user has expressed previous interest in, ads directed to the user based on user information and preferences, or coupons and deals based on the user's profile. This information may be displayed at ATM 102 and provided through printer dispenser 126.

Information may also be provided to and displayed at ATM 102 without being requested by the user or based on the user profile. For example, the top news headlines can be scrolled across an ATM screen. An ATM owner may contract with a vendor to allow the display of information at ATM 102 to the user regarding a new product or upcoming event.

Data can easily be retrieved from ATM 102. For example, central office 106 can request electronic data concerning ATM 102 remotely over data link 104. Also, the ATM operator could manage and verify ATM hardware and software remotely over data link 104 through internal operation terminal 110 and may be able to upload new software or a special configuration file remotely from central office 106. Additionally, online real time recording of events can be done by central office 106 through monitoring of ATM 102 as information is transferred over data link 104. This information can include trend information, the recording of user transactions, and ATM 102 activity. For example, ATM 102 usage by hour can be recorded to determine the peak hours of ATM 102 usage. This information can then be used to tell ATM 102 to operate more efficiently at those times. For example, if a peak period of time is at the lunch hour, ATM 102 may be configured to not offer a full compliment of services and may only offer check cashing, check depositing, and cash withdrawal at that time to limit wait time at ATM 102.

Another service capability offered through data source system 108 may include programming to survey the user and send the results over data link 104 to central office 106 where that information is then used to determine marketing strategies for the ATM owner. This information can be stored at remote client database 116 for real time or future analysis. Data source system 108 may be programmed to process the survey and the results and transfer the results outside of central office 106 for analysis. Upon analysis, new services and information may be provided in the future to the user or similar users of ATM 102.

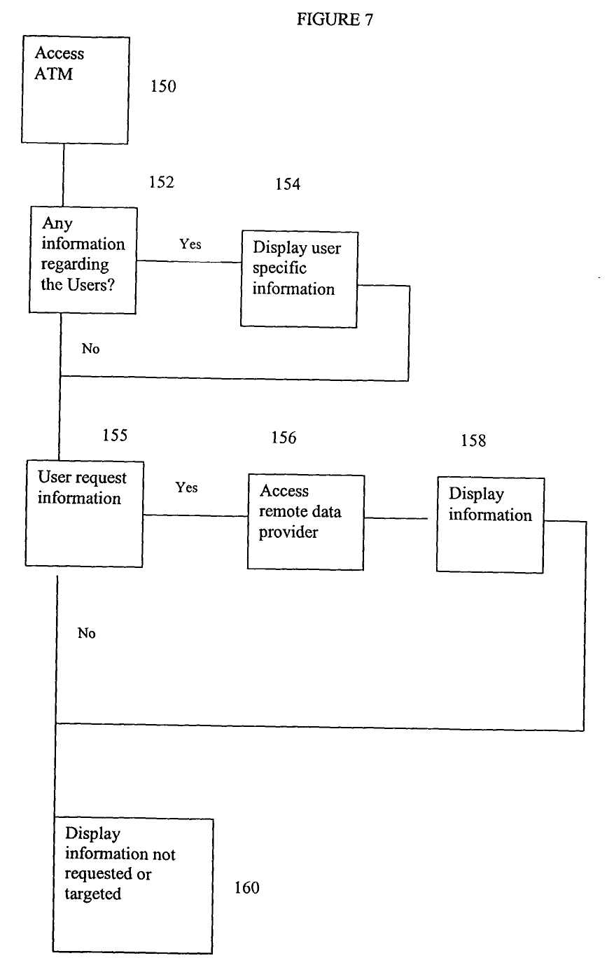

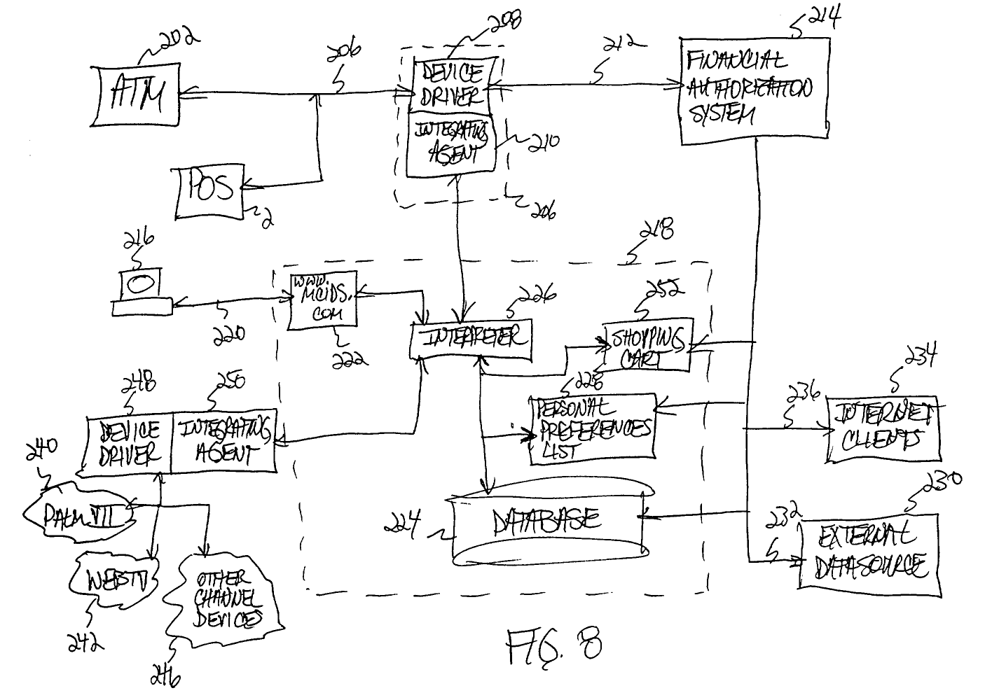

FIG. 7 is a flow chart illustrating an example process implemented in system 100. In step 150, the user accesses ATM 102 as discussed previously. In step 152, ATM 102 communicates with data source system 108 to determine if there is a record for the user in remote client database 116 or internal database 112. If there is, ATM 102 may be adapted to provide information tailored to that user in step 154.

If no information regarding the user is found, ATM 102 may wait to see if the user requests informational services in step 155. These informational services can be one of many services, some of which have been described above. The informational services may be provided to ATM 102 via data source system 108 by remote data provider 114 in step 156. The information is then displayed in step 158. If no information is requested, information from data source system 108 may still be provided based on the wishes of the ATM owner or card owner at step 160.

Data source system 52 provides the interface between an information provider and the ATM 10 user to deliver enhanced content advertising, messages, and information in graphical, video, audio, and print formats. Data source system 52 allows ATM 10 to provide a capability to do more than dispense cash and other banking transactions. Information provided to ATM 102 may be tailored to the user based on profiles or previous activities of the user gathered in internal database 112 or remote client database 116. Transaction data and survey data may be collected from the user and analyzed to adjust what services are to be provided and available through ATM 102.

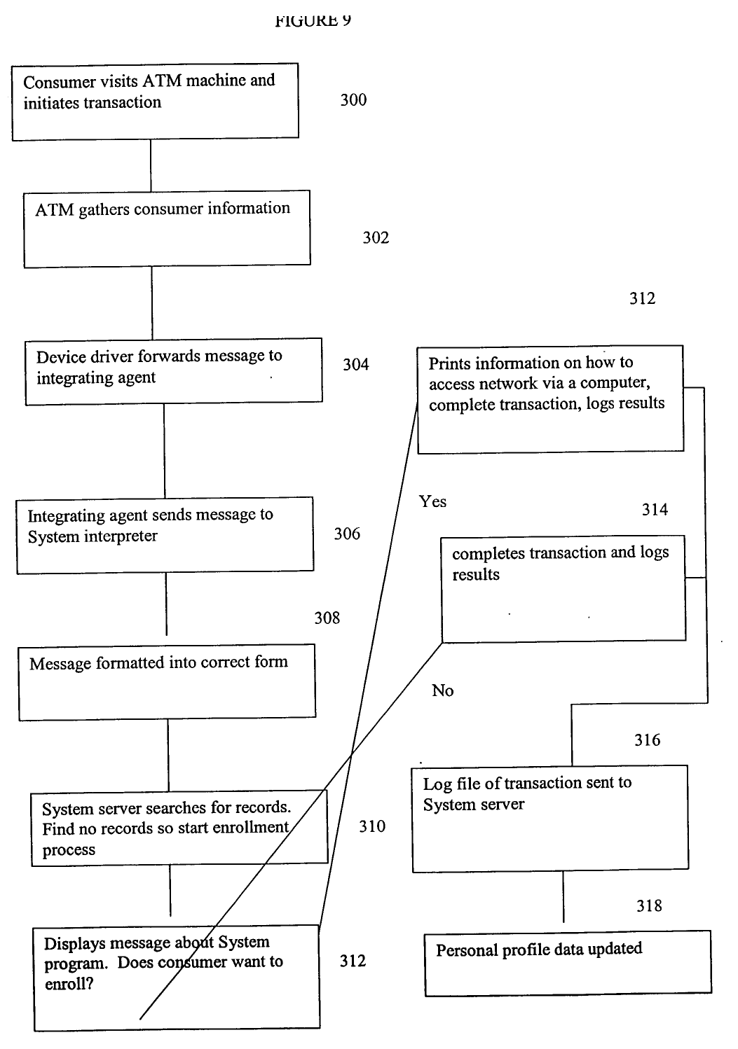

FIGS. 5-7 provide a capability to distribute enhanced content to a user at an ATM. However, the user may have other capabilities to access the enhanced content from devices other than an ATM. Data source system 108 can be expanded into a program that can integrate user access to content at multiple access points. FIGS. 8-12 discuss a capability to deliver enhanced content to a user from multiple delivery channels.

FIG. 8 illustrates a multi-channel interactive distribution system (MCIDS) 200 for the interconnection of automated teller machines and the Internet. MCIDS 200 includes at least one automated teller machine (ATM) 202 connected to an ATM processor 204 by a connection link 206. ATM processor 204 includes a device driver 208 and an integrating agent 210. ATM processor 204 is connected via a link 212 to a financial authorization system 214. MCIDS 200 also includes at least one computer 216 connected to a server 218 through a communication link 220. Server 218 includes a MCIDS website 222, a central database 224, an system interpreter 226, and a personal preference list 228. Server 218 also connects to external data source 230 by a link 232 and other Internet clients 232 by a link 236. ATM 202 is a terminal designed to dispense money or perform other financial or informational transactions after the user has properly identified him or herself. In a typical ATM 202, the user identifies him or herself to ATM 202, typically by use of a card and a personal identification number. After proper identification is made, ATM 202 allows users to perform various financial transactions such as cash withdrawals or balance inquiries. Other functions are also available and are discussed below.

ATM 202 connects via connection link 206 to ATM processor 204. Connection link 206 can be a direct connection between ATM 202 and device driver 208. Connection link 206 can also be a dial up connection, a wireless connection, a fiber optic connection, or any other type of connection. Device driver 208 is used to receive information and format it for the presentation at ATM 202.

While an example will be disclosed in conjunction with ATM 202, the user could access similar information using other channel devices such as a handheld personal digital assistant 240 running Windows CE, Palm OS, or other operating system and having a wireless (such as cellular or packet radio) or wired connection to an informational or financial system. These informational or financial systems are known as “channels”. Also, other terminals such as WEB TV 242, dedicated kiosks, debit card terminals, point of sale terminals devices 244, or other such terminals may be used in addition to ATM 202. In general, these access terminals that provide access to information channels are identified as channel devices 246. These channel devices 246 will have their own media device drivers 248 and integrating agents 250.

Computer 216 is, in one embodiment, a small office/home office computer. Computer 216 may have an Intel or Motorola processor running an operating system such as Windows 3.1, Windows 95/98, Windows NT, UNIX, LINUX, operating systems designed by Apple Computers, or any other operating system application. Computer 216 is also capable of running a browser program and accessing the Internet.

Computer 216 connects to MCIDS website 222 via communication link 220. In this manner, computer 216 is also a channel device with the Internet an information channel. Communication link 220 can be a dial up, direct, wireless/cellular connection fiber optics or any other type of connection. MCIDS website 222 exists at a specific location on the part of the Internet known as the World Wide Web and can contain multiple pages of information that can be linked together. Every website on the World Wide Web can be located by inputting a uniform resource locator into a browser program running on computer 216. MCIDS website 222 offers the user the ability to leave/update information about the user as well as provides additional content to the user. MCIDS website 222 can provide generic information to anyone who visits the site or can provide enhanced functionality to the user who registers with the site. Users who register to access the enhanced functionality of MCIDS website 222 in the MCIDS program will be provided, among other things, information tailored to individual users when the user uses ATM 202 or accesses MCIDS website 222.

MCIDS website 222 is operable to access interpreter 226. Interpreter 226 performs several functions. First, it stores to and retrieves files from personal preference list 228 and any other databases. Interpreter 226 is also operable to format data for presentation to ATM 202 and computer 216 as well as any other type of terminal or endpoint.

Interpreter 226 connects to integrating agent 210. Integrating agent 210 is responsible for requesting data from central database 224. Integrating agent 210 interprets between device driver 208 and central database 224 and provides connectivity to server 218. External data source 230 and other Internet clients 234 connect to server 218 via central database 224 to provide content to ATM 202. One example for providing content to ATM 202 is shown in FIGS. 5-7 discussed above.

In operation, the user of MCIDS 200 would first enroll in the MCIDS program by visiting an ATM 202 participating in the MCIDS program and signing up for the program. When the user signs up for the MCIDS program, the user receives a password to MCIDS website 222. In another embodiment, the user might provide a unique code at ATM 202 to be used as a password. Alternatively, enrollment could take place by sending in a response to a mailing, by directly accessing MCIDS website 222, or by any other means.

After signing up for the MCIDS program at a participating ATM 202, the user can access MCIDS website 222 using an appropriately configured computer 216. Then the user is presented with the initial generic screen for MCIDS website 222. Several options might be presented to the user at this time. One option is to build a personal preference profile. At this point, the user, typically after providing the proper password, may enter a plethora of personal information including information concerning the user's demographics information, the user's interests and hobbies, what type of information the user might want to receive at an ATM 202 or personal webpage, what is the user's usual ATM transaction, etc. The user may respond to as much or as little of the questioning as the user wishes. Other options may include accessing a personal MCIDS page personalized to the user based on user preferences. The user may also be presented with advertisements which can be targeted (specifically selected for the user based on the users profile) or non-targeted.

In one embodiment, users have the opportunity to peruse shopping opportunities at MCIDS website 222. This can be done by either MCIDS 200 presenting targeted or non-targeted buying opportunities to the user or linking to vendor websites. The user can select items to purchase and pay for them on line. In an alternative embodiment, the user can select items to purchase and store the items in a virtual “shopping cart” 252. Shopping cart 252 stores a list of selected items in memory. The user can then pay for the purchase at ATM 202 or some other channel device or can discard the item from shopping cart 252. The advantage of this embodiment is that it allows the user to shop on-line and pay for the purchases at a known and trusted entity.

Once the user is enrolled in the MCIDS program, when the user visits a participating ATM 202, ATM 202 would be able to present the user with information tailored to the user based on the user's personal preference file. An example is the opportunity to purchase an item selected on line. Other examples include the ability to tailor advertisements to specific users. Also, the user's personal preference file may specify a certain favored transaction such as withdraw $50 from checking. The user might also be presented with stock quotes, horoscope, or other information the user chose to receive when setting up the personal preference list. Additionally, an advertisement could be used that required immediate response such as showing an ad for a soft drink and asking the user if the user wants to try the soft drink. If the user reacts positively to the ad, then ATM 202 could dispense a coupon. Other types of media could be dispensed in reaction to an ad including coupons, tickets, smartcards, gift certificates, etc. If the user reacts positively to the ad, then ATM 202 could refer the user to the web for follow up information. This reaction could be counted and logged. This type of advertisement could be displayed to users who are not enrolled in the MCIDS program as well.

In another embodiment, the user may be tracked by the user's actual purchasing and advertising reactions. In this embodiment, a MCIDS account is made associating the user with an account number. From then on, instead of asking for personal information, server 218 will build a personal profile based on actual purchases and reactions. In yet another embodiment, a personal profile may be altered or refined based on the actual purchases and reaction of the user. One goal of MCIDS 200 is that the delivery of information as well as the purchasing of items can be initiated using one channel accessed by a first channel device and the message can be completed at a second channel device accessing a second channel. Another goal is to have the ability to target the delivery of information based on stored user profiles, tracked user behavior, instantaneous user reaction, and/or stored demographics across different channels.

FIG. 9 is a flowchart illustrating one operational embodiment where an non-enrolled user accesses an ATM 202. In step 300, the user goes to ATM 202 that is participating in the MCIDS program. Currently, this user is not enrolled in the MCIDS program. The user, in step 300, activates ATM 202 by either inserting an ATM card or providing some other authentication means. This causes ATM 202 to connect to device driver 208. In step 302, ATM 202 gathers user information such as the card number and PIN number and sends it to device driver 208. Next, in step 304, device driver 208 takes the message and forwards information needed by server 218 to integrating agent 210. This information includes information such as the card number, the terminal location, and any other necessary information required by integrating agent 210. In step 306, integrating agent 210 takes this message and forwards it to interpreter 226. If the user was enrolled, information regarding the user such as card number, terminal number, and any other accessing information needed to find the user's personal profile separated from financial data would be sent to server 218.

In step 308, interpreter 226 accepts the message and formats it into a form usable by the server 218. In step 310, server 218 accepts the message and searches personal preference list 228 for a user's personal preference file and all corresponding data required to formulate a response to the message. In this case, a file will not be found since the user is not yet enrolled in the MCIDS program. Therefore, the MCIDS 200 will do the following. First, it creates a temporary user's personal preference list. This list will be a default list including the card number and ID information the user used. Next, it will generate a unique alphanumeric code tied to that user profile. This will be a password the user can use later on to access server 218 via a channel device 246. Next, it will generate an expiration date for the temporary file and alphanumeric code that will cause the file to be deleted after a certain period of non-use. Then, the code and expiration date will be entered into the temporary user profile. Finally, a disclosure statement based on where the card is used or where the terminal is located might be generated. Disclosure information would disclose information regarding the use of the personal information in MCIDS 200 as well as any necessary listing of user rights depending on what state or location ATM 202 was used in. This response is formulated and then forwarded to interpreter 226.

ATM 202 will hold the authorized transaction request received from the financial authorization system 214 until signaled to complete the transaction. Current financial authorization systems 214 are used by or operated by organizations such as credit card and debit card issuers. These financial authorization systems 214 are operable to approve financial transactions started at ATM 202. Here, the primary transaction, such as a withdrawal of money, will be held until a signal is received indicating that the following steps have been completed. During this time, a typical ATM 202 will display a message asking the user to please wait (the “please wait” message). Instead, in step 312, during the “please wait message”, the following information would be displayed. First, a message encouraging the user to enroll in the MCIDS program and build a personal preference list is displayed. After this message is completed, the terminal will prompt the user to react in a certain way such as are they interested, would they like more information, etc.

If the user reacts positively, the terminal prints and/or dispenses the following information on a piece of paper, separate from any transaction receipt, that shows how to build the user preference page at MCIDS website 222 in step 313. The paper would also include information regarding the alphanumeric code generated for the user and would indicate how long the user has to enroll before this code expires. Any additional disclosures required by law would also be dispensed, either dynamically printed or preprinted and stored in a canister. If the user responds negatively, the terminal completes the transaction and logs the user's response in step 314. Once this is completed, a signal is sent authorizing the completion of the original transaction, such as the dispensing of the cash requested and the appropriate debiting from a checking or savings account. ATM 202 logs all the messages displayed and the action taken by the user. Also, in one embodiment, if MCIDS 200 has enough information to track the ATM card number with the user, then an ad hoc profile can be built over time.

In step 316, ATM 202 sends a log file of all transactions completed to device driver 208 for journal entry and logging purposes at server 218. Device driver 208 sends integrating agent 210 the required information relating to targeted impressions and the user reactions taken in step 312. Integrating agent 210 forwards this information to interpreter 226, which forwards it to server 218. Server 218 will accept the log and use that information to update the user personal preference list 228. This list reflects the impressions presented and the user reactions to the impression. In the case of a yes response, personal preference list 228 is updated at step 318 with that response. A no response is also indicated in MCIDS 200 and that user would not be shown the join message again or at least not until a certain time expires. Any information taken at ATM 202 is logged and information regarding ATM 202 is also logged indicating that ATM 202 has generated a successful referral if a yes response was received. At the end of this process, the user is now enrolled in the MCIDS program. The user can now use any channel device 246 in MCIDS 200 to access server 218.

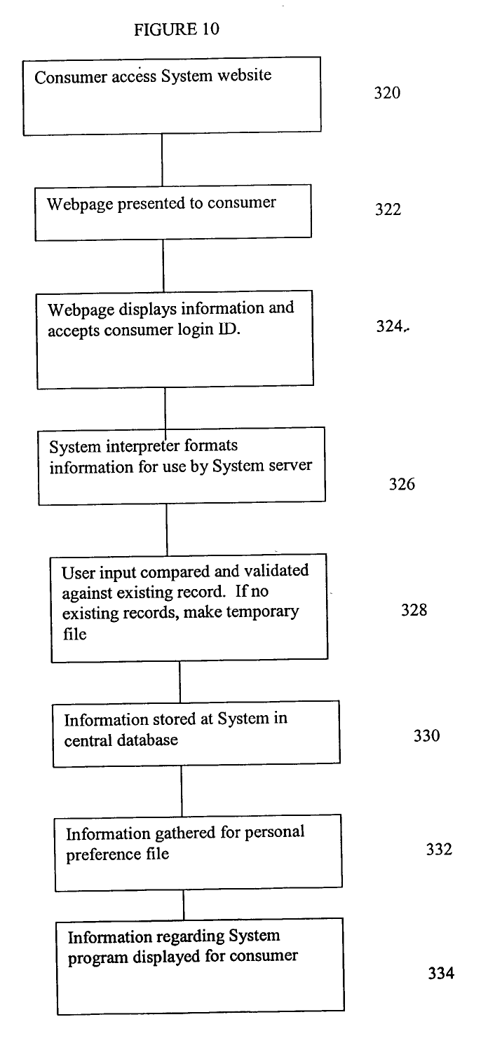

FIG. 10 is a flowchart illustrating the user's use of MCIDS 200. In step 320, the user logs on to the world wide web through an Internet service provider to access the generic MCIDS website 222 (by accessing, for example, a URL of www.MCIDS.com). In step 322, a webpage is presented. MCIDS website 222 supports numerous links and informational topics relating to MCIDS services. The information may include where ATMs 202 participating in the MCIDS program are located, what merchants participate in the program, and any necessary disclosure information. MCIDS website 222 also prompts for the alphanumeric code received by the user at ATM 202 as described in FIG. 9. Once the information about MCIDS services and the alphanumeric code is received in step 324, it is forwarded to interpreter 226.

In step 326, interpreter 226 accepts that input and formats it to be read by the server 218. In the step 328, server 218 accepts user inputs and attempts to validate it against existing personal profiles. If there is an existing record, then that personal profile is activated. If this is the first access, a temporary personal profile is activated. Next, server 218 formulates questions including a request for the user's name and a new password for the user as well as sending a blank enrollment form to the user to create a personal preference list. Additionally, any disclosure statement that is necessary is sent.

In step 330, interpreter 226 accepts the response and stores information at central database 224. In step 332, server 218 prompts the user to choose a personal ID and password in order to create a personal webpage. The user is also prompted to create a personal preference list 228. This information is sent to interpreter 226, which in turn forwards it to server 218 which in turn validates the new record against the active record and stores an updated record. In step 324, interpreter 226 sends information to MCIDS website 222 regarding instructions, benefits, rewards, etc. regarding the MCIDS program. At this point, the user might be able to store a typical ATM transaction such as always make a twenty-dollar withdrawal from checking or choose what information is to be displayed at any ATM 202 such as a stock quote on existing stocks in a portfolio or even the user's horoscope when the user accesses a participating ATM 202. Additionally, targeted or non-targeted ads or opportunities to purchase products could be presented at MCIDS website 222, or at the user's now personal website, based on that user's personal preference. The advertisements and opportunities to purchase products might also be based on the user's response.

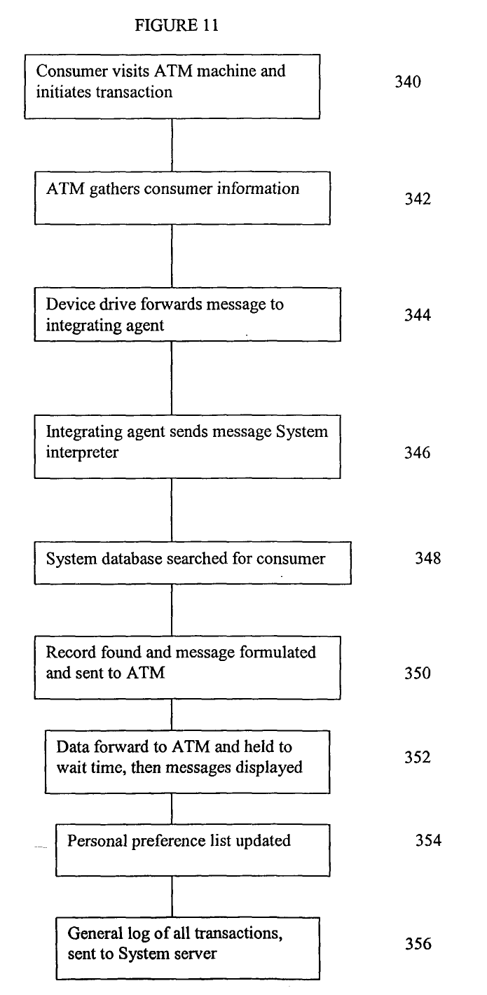

FIG. 11 is a flowchart illustrating the use of a MCIDS program once the user is enrolled. The first four steps 340, 342, 344, and 346 of FIG. 11 are the same as steps 300, 302, 304, and 306 of FIG. 9. Turning to step 348 in FIG. 11, server 218 accepts messages and searches database 224 for the personal preference list 228 of the user, formulates a response, executes any necessary instructions, and sends that information through interpreter 226. In step 350, interpreter 226 formats messages depending on the type of ATM 202 that is being used. The messages are presented to integrating agent 210. Integrating agent 210 sends that information to device driver 208. This information can include information regarding the user's usual transaction, stored in his personal preference list 228, such as always withdraw one hundred dollars from checking. It may also include predefined data information that the user wants to see at ATM 202 including stock quotes or horoscope information. It may also include information regarding selections made on the Internet that may be paid for at ATM 202 or other fulfillment information. These messages are prioritized and held for the wait sequence. In step 352, device driver 208 forwards the information to ATM 202. Again, the terminal information regarding the primary transaction is held until other information is completed. This means, during the usual please wait period, the terminal will display the user's messages. These messages might be prioritized based on the importance of the messages. For example, the first priority message could be a prompt for the user to pay for an item that was selected at MCIDS website 222. The next level of priority messages could be a prompt for the user to fulfill a selection from the personal website. Next could be targeted messages such as ads targeted based on the user's profile stored at MCIDS website 222. Next can be non-targeted random messages.

If a sale was pending, the ATM 202 would prompt the user to verify the selection, the amount, and ask the user how the user wants to pay for that purchase. The user may also cancel a product selected online. This gives the user the option to pay using a different card than that used to activate ATM 202. When this transaction is sent for authorization, any other purchase transaction may be completed. ATM 202 continues through the priority list for all the messages and information requested or designed to be sent to the user until all of them are finished. ATM 202 logs all messages presented to the user and the actions taken by the user. ATM 202 can print any information necessary for the purchases.

Next, in step 3544, ATM 202 will send a general log file of all transactions to device driver 208. Device driver 208 sends the integrating agent 210 all information regarding transactions relating to MCIDS 200. Integrating agent 210 then sends interpreter 226 that information. Interpreter 226 sends the log file and instructs to server 218 at step 356. This updating information includes closing out canceled selections and fulfilling pending orders. It also logs impressions presented to the user and the user's reaction to those impressions. It could log terminal action taken at the time of the transaction and any referrals to any websites that were presented to the user during the use of ATM 202. Other profiles are also updated at this time.

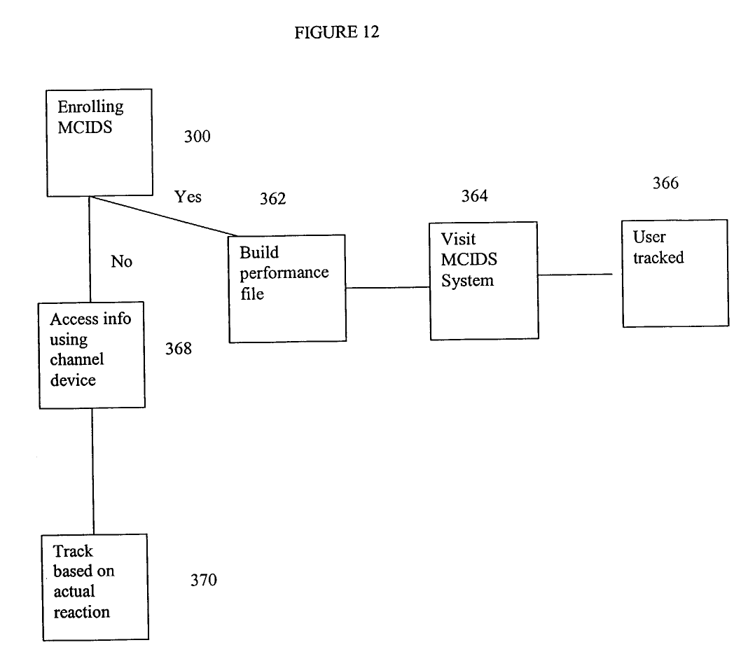

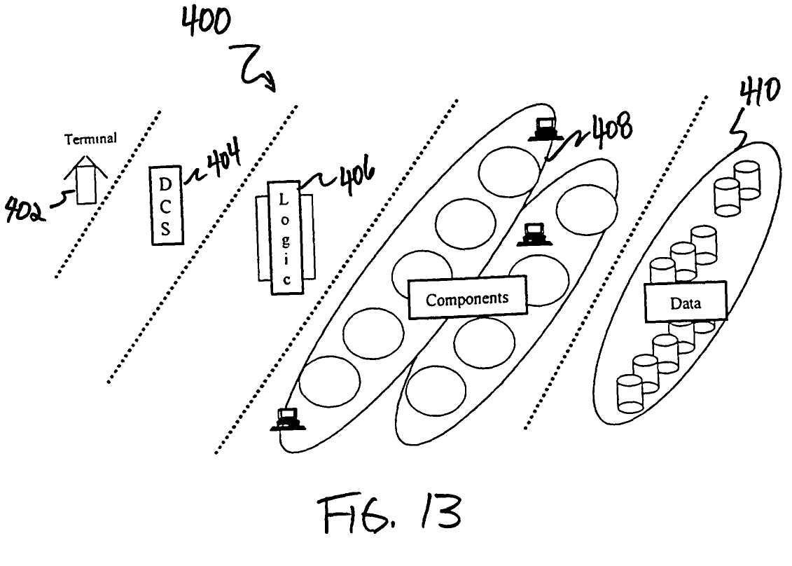

FIG. 12 is a flowchart illustrating the operation of MCIDS 200. The user's card number or other personal identification number used to activate ATM 202 is recorded and stored in a file. In this manner, the user and ATM card number are associated. This allows for the tracking of non-enrolled users. In this way an ad hoc file could be built about the user.

In step 360, the user is given the opportunity to enroll in MCIDS 200. The opportunity to enroll may come from one or more different areas. For example, the user might visit an ATM 202 which participates in the MCIDS program. When the user is using ATM 202, ATM 202 displays a message inviting the user to join the MCIDS program. If the user reacts positively to this message, a file is created for the user indicating that he wants to participate in the MCIDS program. The user is given a web address and password in order to log onto MCIDS website 222 and enter personal information. If an ad hoc, or system-derived profile exists, then the user's self-defined personal preference list 228 is merged with the existing profile to create a more dynamic user profile.

If the user decides that he or she is not interested in the MCIDS program, the user would indicate that preference and a file would be made for that user indicating not to display the enrollment information again (or not to display the enrollment message for some time period). Although, a non-enrolled user is not trackable by a personal preference list, the user can be tracked using the stored identification number. The system-derived profile would continue to evolve when the user interacts with any of the channel devices in MCIDS 200.

In another embodiment, the user might enroll in the MCIDS program directly via MCIDS website 222. In this embodiment, the user might access the generic MCIDS website 222, read information about the MCIDS program and decide to enroll. By choosing to enroll, the user might be given a password and user name to access a portion of MCIDS website 222 where the user profile can be built. Again, if an ad hoc or system-derived profile exists, then the user's self-defined personal preference list 228 is merged with the existing profile to create a more dynamic user profile.

In another embodiment, the user could enroll in the MCIDS program at a bank or other financial institution. In this example, when the user receives his initial ATM card, he or she might be asked whether or not he or she wants to enroll in the MCIDS program. In case of a positive response, the user might fill out information for a personal profile at the bank which can later be processed for the MCIDS program. Alternatively, the bank may simply provide the user with a web address that the user can access to enter personal information. If the user decides not to enroll, an identification number can still be associated with the file.

In yet another embodiment, the user may receive a direct mail solicitation regarding the MCIDS program. In this case the user may either return a questionnaire which can be used to build personal preference list 228 or the user may be given a web address and password to access MCIDS website 222 to enter personal preference information as was done in the ATM example.

After the enrollment process is complete there are two groups of individuals. One group are individuals who have enrolled in the MCIDS program. The other group are those who have chosen not to enroll. The users who are not enrolled can be tracked by MCIDS 200. This is known as an ad hoc profile and is based on actual choices made by the user. The users who enroll in the MCIDS program can be tracked based on personal preference list 228 and on an ad hoc profile. The ad hoc profile can be used to refine personal preference list 228.

In step 362, the user that chooses to enroll may build personal preference list 228. As indicated above, this can be done in one or more locations. In one embodiment, once the user accesses MCIDS website 222 they can go to a page of MCIDS website 222 where personal information concerning the user can be entered. This information can include a wide variety of data concerning the user, the user's buying habits, the user's spending habits, the user's usages of ATMs 202, the user's usages of the Internet and other items. The user can answer as many or as few questions as they want and personal preference list 228 is then saved in a file stored at database 224 for future references. In other embodiments, questionnaires sent via mail or given to the user at a bank or other financial institution can be filled out and then entered into a computer system. No matter where the information is entered, the key factor is that personal preference list 228 is stored in MCIDS 200 with information concerning that user.

In step 3648, the enrolled user visits MCIDS 200 through one of the channel devices. Depending on the type of channel device, different information might be displayed. The user may be exposed to advertising and other information directed towards that user based on personal preference list 228. In one embodiment, ads might be presented which are specifically targeted towards the user based on personal preference list 228. For example, personal preference list 228 of the user might indicate that the user likes to eat at a particular fast food restaurant. When the user accesses MCIDS 200 via a channel device, an ad for the particular fast food company may be displayed based on the information stored in personal preference list 228.

In addition to ads which are targeted to an individual based on personal preference list 228, non-targeted ads might also be displayed. One purpose of these ads may be to gauge user interest in a product. For example, the advertisement may offer a new type of service for cellular telephones. Based on the user's response, the user's personal preference list 228 may be updated indicating that the user wants to receive more information concerning cellular telephone deals at a different channel device. An example of this would be the user at an ATM 202 receiving a message concerning cellular telephone rate plans at the ATM 202.

The ad may ask for a response from the user to see if more information is wanted. If the user responds that he wants more information, then the ATM 202 might direct the user to a website or a location where more information about the cellular plan could be received. A notation can then be made in the user's personal preference list 228 indicating an interest in the cellular phone plans. When the user accesses the MCIDS program using a different channel device, the user should be able to view the requested information. Alternatively, more information could be displayed at that ATM 202, the user may be directed to a specific website, or information may be sent via electronic mail or regular mail to the user requesting that information.

Another type of non-targeted ad might be an ad for a product such as coffee. After viewing the ad at a kiosk or perhaps an ATM 202, the ad may ask for the user reaction such as “I want more information about this product” or “I do not want more information about this product.” In the case of choosing more information about the product, the ATM 202 or other channel device may cause coupons or other incentives to be dispensed. Information regarding the positive or negative response to non-targeted ads will be tracked on an ad hoc basis with personal preference list 228 to help fine tune and update personal preference list 228. Thus, an ongoing learning personal preference list 228 will continually enhance the user's experience at the channel device as MCIDS 200 gets better at providing the right information to the right person at the right time.

Additionally, the user might be able to choose to buy certain items at a channel device. These items may then later be paid for using a different channel device. For example, the user accessing MCIDS website 222 might find a pair of earrings that the user wishes to purchase at MCIDS website 222 or other websites. The user however may be unwilling to pay for an item on the Internet or the user may not be near a PC with Internet access when the user decides to purchase the product. In that case, the user may initially select an item for purchase using one channel device. Then the user uses a different channel device to pay for the item. For example, the user may be tempted with an offer to buy a product while at home using a home computer. The user may select the product and indicate that they want to purchase the product on the computer. However, the user, may not trust giving a credit card over the Internet. The user then chooses to delay paying for the item until the user has an opportunity to access a more secure channel device such as an ATM 202. When the user uses the ATM 202 the next time, the user will be presented with the fact that they had selected an item for purchase. The user will then be given the opportunity to either pay for the item at that point, continue to wait to pay for the item, or to cancel the selection. If the user so chooses, that item can be purchased at the ATM 202. Of course, if the user trusts the Internet as a means of buying goods, then it could be purchased at that Internet site. This example shows the advantage of selling and delivering information and services and products over diverse channels.

In addition to advertisements and the opportunity to purchase items, the user might also be shown information tailored to that individual specifically when the individual accesses MCIDS 200 via a channel device. For example, the user might have indicated in their personal preference list 228 that they wish to see information such as stock quotes and daily horoscope whenever they access an ATM 202. When the user accesses the ATM 202, the additional information will be displayed by the ATM 202. This information may also be delivered based not on the personal preference list 228 of the user but based on the ad hoc determination of the user's actual behaviors. Through the user's personal preference list 228, the user might be able to set up what information is displayed at what channel device in order to have information tailored and delivered to the user at the appropriate time and place.

In step 366, an enrolled user is tracked. In the case of an enrolled user, there are two ways of tracking that user. First, the user can be tracked based on the ad hoc profile created and changes made to the personal preferences list 228 as information is gathered and stored in MCIDS 200. Secondly, the user's actual response to an inquiry can also be recorded and saved. The key capability is in continually tracking and enhancing the user's stated preferences and actual behavior over a multiple number of information channels.

In step 368, the user who chooses not to belong to the MCIDS program uses a channel device to access information. The results would be similar in this case to what happens to an enrolled user in step 364 except there would be no targeted advertisement, sales, or information based on a personal preference list 228. However, if enough information is known about the user, i.e., if at some point in time a credit card or debit card number was associated with a file, then that user's preferences can be tracked in an ad hoc manner. For example, reactions to non-targeted advertisements or sales will be tracked based on the user's actual reaction to those products. Then, information can be targeted to the non-enrolled user based on past preferences. Therefore, in step 370, a non-enrolled user is tracked based on actual reactions to non-targeted offers for sales, advertisements, and information as well as selections made during the channel device session. In this manner, non-enrolled users are tracked based on past preferences without the inclusion or benefit of reported preferences.

FIG. 13 shows a generic structure 400 of an implementation of MCIDS 200. MCIDS 200 is based on generic structure 400 that includes a terminal section 402, a device control section 404, a logic section 406, a components section 408, and a data section 410. Terminal section 402 includes any device connected and operated for the purpose of user transactions or delivering information and content to those users. Terminal section 402 may include ATM 202 or any other channel device 246. Device control section 404 provides the primary interface with terminal section 402 and has the most complete information and knowledge of how to communicate with and control the hardware and software within terminal section 402. Logic section 404 performs routing, prioritization, and synchronization of content and request flow to and from device control section 404. Component section 408 provides applications that handle the functionality provided at terminal section 402. Data section 410 provides the content that is delivered to and from terminal section 402 and information to allow component section 408 to make decisions and support the functionality at terminal section 402.

Terminal section 402 accepts inputs from the user in the form of cards, deposits, keystrokes, cash, as well as enhanced inputs such as smartcards, fingerprints, and retina scans. Terminal section 402 may dispense items from canisters, print items for dispensing, or display graphics based on transaction selection, services requested, user or system commands, and terminal configurations. Terminal section 402 may be connected over various physical communications networks using any of various protocols. Terminal section 402 supports vendor specific and proprietary hardware and software, pre-configured transaction flows, and files for fast response to the user.

Device control section 404 coordinates the device handler and screen loads for terminal section 402 in order to create the transaction experience. Device control section 404 interfaces with online transaction and monitoring systems. Device control section 404 keeps track of transaction types for subsequent reconcilliation, settlement, and problem resolution. First line validation of the user interaction is performed in device control section 404 including user authentication and input selections made by the user. Device control sectiom 404 coordinates the timing of events and messages to make the user's experience consistent and seamless by providing appropriate commands to terminal section 402.

Logic section 406 functions as the traffic cop between device control section 404 and component section 408. Logic section 406 compares the compatibility of terminal section 402 with responses within the system in order to make decisions on product and service delivery. Logic section 406 prioritizes and synchronizes events from component section 408 and device control section 404 in order to complete the user transaction experience. Logic section 406 prioritizes terminal definitions and user selections to determine which part of component section 408 is required. Logic section 406 also can change the user experience based on responses from component section 408 and actions from device control section 404.

Component section 408 provides the applications that are the heart of the functionality of terminal section 402. Component section 408 fulfills requests received from logic section 406 and returns appropriate responses thereto. Component section 408 extracts and updates information located in data section 410. Interaction of applications is performed in component section 408 in order to support a service or product offering presented by terminal section 402. Applications within component section 408 make decisions and submit responses and messages based on requests received and data available in data section 410. Component section 408 also determines which applications to access in response to the request received and the data required.

Data section 410 includes databases organized for efficient accumulation and retrieval of information processed within generic structure 400. Information within data section 410 is distributed and used at all points within generic structure 400 through component section 408. Information maintained within data section 410 may include system generated events in real time or batch form, information gathered from the user, information gathered from a device in terminal section 402, information entered by operator personnel, and information gathered from external databases.

MCIDS 200 may use legacy, modern, and hybrid platforms that create a flexible and dynamic environment for the quick turnaround of software, communications, and application level additions, changes, and repairs. MCIDS 200 supports value based services through user and industry analysis of the functional and business requirements provided at ATM 202. MCIDS 200 provides content management through data and presentation content at ATM 202. MCIDS may also provide unlimited services at ATM 202 by identifying, tracking, reporting, and billing any service made available at ATM 202.

Thus, it is apparent that there has been provided, in accordance with the present invention, a system and method for providing enhanced information content to a user of an automated teller machine. Although the present invention has been described in detail, it should be understood that various changes, substitutions, and alterations may be readily ascertainable by those of skilled in the art and may be made herein without departing from the spirit and scope of the present invention as defined by the following claims.

What is claimed is:

1. A system for providing information and services to and from an automated teller machine (ATM) comprising:
a central office;
an ATM coupled to the central office, the ATM operable to perform a bank transaction in response to user interaction;
a remote data provider coupled to the central office, the remote data provider operable to provide non-bank transaction content to the ATM through the central office.

2. The system of claim 1, wherein the content is news, weather, and/or sports information.

3. The system of claim 1, wherein the content is access to electronic mail.

4. The system of claim 1, wherein the content is Internet access.

5. The system of claim 1, wherein the content is access to a ticket brokerage.

6. The system of claim 1, wherein the content is financial information.

7. The system of claim 1, wherein the central office includes a data source system coupled to an internal operator and an internal supporting database.

8. The system of claim 7, wherein the data source system is operable to provide an interface between the ATM and the remote data provider.

9. The system of claim 7, wherein the internal operator is operable to monitor the flow of content to and from the ATM.

10. The system of claim 7, wherein the internal supporting databases are operable to provide data storage for information from the remote data provider.

11. The system of claim 1, which the central office is operable to receive ATM journal information directly from the ATM via a communications link on demand.

12. The system of claim 1, wherein the central office is operable to provide real time recording of events occurring at the ATM.

13. The system of claim 12, wherein the information provided by real time recording can be used to determine trends of ATM operation and activities of users of the ATM.

14. The system of claim 13, wherein the capabilities of the ATM are changed based on the trends.

15. A method for providing information and services at an automated teller machine, comprising:
requesting enhanced content from a central office based on a user selection;
retrieving the enhanced content from a remote data provider;
receiving enhanced content from the central office; and
displaying the enhanced content at the ATM to a user.

16. The method of claim 15, wherein the enhanced content is news, weather, and/or sports information.

17. The method of claim 15, wherein the enhanced content is access to electronic mail.

18. The method of claim 15, wherein the enhanced content is Internet access.

19. The method of claim 15, wherein the enhanced content is access to a ticket brokerage.

20. The method of claim 15, wherein the enhanced content is financial information.

21. The method of claim 21, further comprising:
monitoring the flow of content to and from the ATM.

22. The method of claim 21, further comprising:
providing data storage for information from the remote data provider.

23. The method of claim 15, further comprising:
providing ATM journal information directly from the ATM via a communications link on demand.

24. The method of claim 15 further comprising:
monitoring the ATM in real time;
recording events occurring at the ATM.

27. The method of claim 26, further comprising:
determining trends of user and ATM activity;
modifying ATM capabilities based on the trends.
